(19) United States
(12) Patent Application Publication
(10) Pub. No.: US 2007/0294028 A1
(43) Pub. Date: Dec. 20, 2007

(54) Route Optimization Apparatus & Method

(76) Inventors: Don Chanachok Gray, Chermside (AU); Ahmad Bahir, Eight Mile Plains (AU); Nhut Luke La, Collingwood Park (AU); Ben Wong, Toowong (AU)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 10/553,921

(22) PCT Filed: Apr. 30, 2004
(86) PCT No.: PCT/AU04/00575

§ 371 Date: Jul. 12, 2007

(30) Foreign Application Priority Data
Apr. 30, 2003 (AU) 2003902042

(51) Int. Cl. G01C 21/34

(52) U.S. Cl. 701/209

(57) ABSTRACT

An apparatus for generating an optimised route between a plurality of locations comprises processing means in communication with the following: input means to enable a user to identify the plurality of locations, storage means for storing geographic data, a data handling engine for converting the locations into data representative of the plurality of locations by reference to the storage means, a route calculating engine for calculating an optimised route between the plurality of locations on the basis of said representative data, an image rendering engine for generating a series of images, each image of the series comprising a part of the optimised route between two of the identified locations and output means for outputting the series of images.

### FIELD OF THE INVENTION

The invention relates to a route optimization method and apparatus. In particular, although not exclusively, the invention relates to a method and apparatus for generating a quickest and/or shortest route to deliver items to and/or collect items from a plurality of locations.

### BACKGROUND TO THE INVENTION

When delivering items to and/or collecting items from multiple locations, it is usually desirable to minimise the distance travelled between the locations and more particularly to minimise the time taken to perform the deliveries and/or collections. For example, a delivery person for a pizza company will usually deliver a number of pizzas from a production location to a plurality of different customers situated at different locations. The delivery person usually reviews the destinations for the pizzas, consults a map of the delivery area to locate the destinations and determines their own route to deliver the pizzas with reference to a street directory.

In another example, courier firms usually have a central distribution depot responsible for a particular area or territory from which couriers pick-up packages, which are delivered to multiple locations by a courier. The courier usually also collects packages from multiple locations, either during the same trip or in a separate trip. The collected packages are then delivered back to the central distribution depot, e.g., for transportation interstate or overseas. Although the courier firms can track their vehicles and the packages being collected and delivered, the driver is not provided with any assistance in determining the order of their deliveries and/or collections. The courier usually consults a street directory or the like to identify destinations and collection locations and mentally works out a route in an attempt to most efficiently make their deliveries and/or collections.

It is usually desirable to minimize delivery and collection times to maximize the number of possible deliveries/collections; to minimize overheads such as fuel consumption and wear and tear on vehicles; and in numerous cases such as the pizza example, to preserve the product being delivered/collected. Conventionally employed methods of manually consulting a street directory, map or the like to devise an optimum route are time consuming and prone to human error. Furthermore, there have been numerous fatal collisions caused by drivers consulting street maps and the like whilst driving.

In-vehicle navigation equipment such as GPS is readily available, which assists a driver in travelling from a first location to a second location, but such equipment does not provide an optimized route for the delivery/collection of items to/from multiple destinations/locations. Another drawback of such systems is their cost, which renders the provision of a GPS receiver to each delivery vehicle/person prohibitively expensive, especially for smaller organisations.

Furthermore, the maps generated by GPS receivers can often be difficult to read and interpret because of the minimal information that they display. This is due to the limited processing power in the receivers and because vector data is employed, both of which enable the receiver to quickly generate and update simple maps as the user is driving and changing position.

Another method of route determination utilises Geographic Information Systems (GIS) software that can accurately determine map coordinates for a delivery/collection location. For example, U.S. Pat. No. 6,470,268 assigned to Horizon Navigation, Inc. discloses a system that employs a GIS to determine delivery/collection paths. A symbolic representation of location information in the form of a barcode or holographic image, referred to as a glyph, is generated and attached to a package. A plurality of glyphs may be scanned to input the location information from each glyph to a navigation system. The navigation system uses the GIS to calculate an optimized delivery path to minimize delivery time and/or distance for delivery of the packages. Whilst this system provides an optimized route to aid delivery, the requirement of the glyph for coding and storing location information increases the complexity and cost of the system.

Another problem with known route optimisation equipment is that it can be difficult for the user to understand the route and/or directions associated with the optimized route. This may be because the route is depicted on a screen that is often small in size and difficult to view. Additionally or alternatively, the optimized route is often displayed with the minimal amount of information to minimize processing or avoid a crowded display, as with many GPS receivers.

Hence, there is a need for a system, apparatus and/or method that generate an optimized route for delivery to/collection from multiple locations that addresses or ameliorates at least some of the aforementioned problems of the prior art.

### SUMMARY OF THE INVENTION

In one form, although it need not be the only or indeed the broadest form, the invention resides in a method of generating an optimized route between a plurality of locations, said method including the steps of:

(a) identifying the plurality of locations;

(b) converting the locations into data representative of said plurality of locations by reference to a store of geographic data;

(c) calculating an optimized route between the plurality of locations on the basis of said representative data; and

(d) generating a series of images, each image of said series comprising a part of the optimized route between two of the identified locations.

Suitably, step (b) includes determining longitude and latitude coordinates representing each location by referring to a look-up table.

Preferably, step (d) includes automatically scaling each image on the basis of the part of the optimized route to be generated on said image.

Suitably, the method further includes the step of storing each point along the optimized route in terms of longitude and latitude coordinates.

Preferably, automatically scaling each image further includes determining maximum and minimum longitude and latitude coordinates of the optimized route.

Optionally, the method further includes the step of splitting an image into two or more images where a scale of the image renders information of the image unclear or illegible to a user.

Suitably, a user may select one or more features along the optimized route at which to split the image.

Suitably, the method further includes the step of generating one or more advertisements on one or more parts of one or more of the images.

Preferably, selection of the one or more advertisements is on the basis of a region represented by the image.

Suitably, an origin and/or a destination of the optimized route are automatically specified prior to calculating the optimized route.

Optionally, the method further includes the step of specifying one of said plurality of locations to be the first destination of the optimized route.

Suitably, each image is a map printed onto printable media.

Optionally, step (a) includes specifying a customer identifier to identify at least one of the locations by reference to a store of customer data.

In another form, the invention resides in an apparatus for generating an optimized route between a plurality of locations, said apparatus comprising:

processing means coupled to be in communication with:
input means for identifying the plurality of locations;
storage means for storing geographic data;
a data handling engine for converting the locations into data representative of said plurality of locations by reference to said storage means;
a route calculating engine for calculating an optimized route between the plurality of locations on the basis of said representative data;
an image rendering engine for generating a series of images, each image of said series comprising a part of the optimized route between two of the identified locations; and
output means for outputting said series of images.

Preferably, the storage means comprises a look-up table of longitude and latitude coordinates representing each location.

Preferably, the apparatus further comprises a scaling engine for automatically scaling each image on the basis of the part of the optimized route to be represented on said image.

Suitably, the apparatus further comprises a store of customer data to identify at least one of the locations on the basis of a customer identifier.

Further features of the invention will become apparent from the following detailed description.

### BRIEF DESCRIPTION OF THE DRAWINGS

To assist in understanding the invention and to enable a person skilled in the art to put the invention into practical effect preferred embodiments of the invention will be described by way of example only with reference to the accompanying drawings, wherein:

FIG. 1 shows a schematic representation of the apparatus according to an embodiment of the present invention;

FIG. 2 shows a flowchart of steps involved in the method according to an embodiment of the present invention;

FIG. 3 is a representation of the user interface in basic mode;

FIG. 4 is a representation of the user interface in advanced mode;

FIG. 5 is a representation of the user interface in advanced mode;

FIG. 6 shows the first in a series of images showing part of the optimized route;

FIG. 7 shows the second in a series of images showing part of the optimized route;

FIG. 8 shows the third in a series of images showing part of the optimized route;

FIG. 9 shows the fourth in a series of images showing part of the optimized route;

FIG. 10 shows a list of directions for each part of the optimized route;

FIG. 11 shows a perspective view of the apparatus according to an embodiment of the present invention; and

FIG. 12 shows another perspective view of the apparatus in FIG. 11.

### DETAILED DESCRIPTION OF THE INVENTION

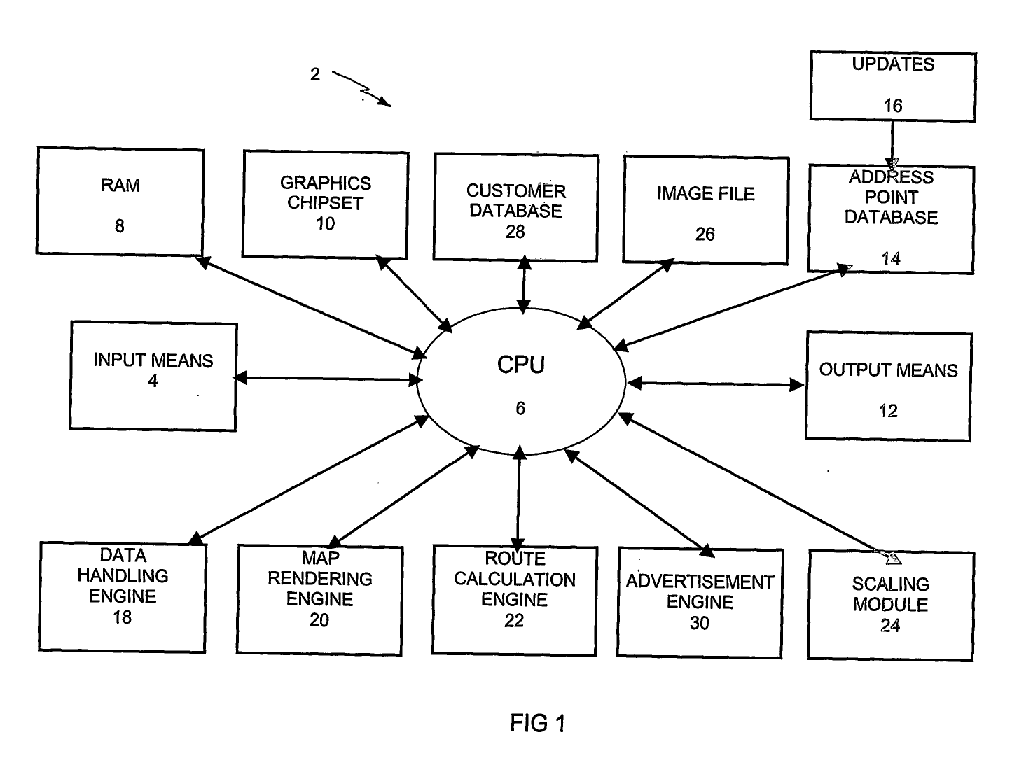

With reference to FIG. 1, apparatus 2 of the present invention comprises an input means 4, such as a keyboard or touch sensitive screen, coupled to be in communication with processing means 6. Processing means 6 may be any suitable, commercially available processor familiar to persons skilled in the relevant art, such as a Pentium III by Intel Corporation, capable of executing the operations described hereinafter in a time frame of the order of seconds or less. Processing means 6 is also coupled to be in communication with memory 8, which is preferably 1 GB RAM or greater capacity, a graphics chipset 10 and to output means 12, such as a screen and/or printer. Preferably, input means 4 is in the form of a touch sensitive LCD screen displaying a conventional keyboard and menus and the like that also functions as an output means and therefore functions as a graphical user interface (GUI).

Processing means 6 is also coupled to be in communication with storage means 14 in the form of an address point database that stores geographic data. In one embodiment, updates 16 to the stored geographic data are provided via CD-ROM and are uploaded via a CD-ROM drive. Processing means 6 is further coupled to be in communication with a data-handling engine 18, map rendering engine 20, route calculation engine 22, scaling module 24, image file 26, customer database 28 and advertisement engine 30, the function of each being described hereinafter.

Storage means 14 stores geographic data and in one embodiment is in the form of a look up table comprising addresses and longitude and latitude coordinates describing the location of each address, an example of which is shown in Table 1. Such data is available from, for example, Mapinfo.

TABLE 1

| Street number | Street name | Suburb name | Latitude | Longitude |
|---|---|---|---|---|
| 25 | Smith St | Collingwood | 112.4503 | −29.4932 |

In this example, the street name, street number and suburb name of a location are stored, which has associated latitude and longitude coordinates describing the location. Any combination of such identifiers for a location may be stored, providing the particular combination is sufficient to accurately identify the location. The identifiers are not limited to those specified in Table 1 or the format in which they are specified. For example, additional and/or alternative identifiers may be employed, such as place/building/location names, e.g. Woolloongabba Stadium, Empire State Building.

In a preferred embodiment, the content of the geographic data in storage means 14 is limited to an area, territory, city or other region for which the apparatus and method of the present invention will be employed. This enables a provider of the apparatus to limit its use to a geographical area. Updates 16 to the stored geographic data ensure that the geographic data is current and contains recent developments, such as new thoroughfares and housing developments. Commercially available data sources, such as those from Mapinfo are updated approximately every 3 months, which is sufficient to keep track of such changes. In an alternative embodiment, updates may be downloaded to the storage means 14 by any suitable means known to persons skilled in the relevant art, such as via a global communications network such as the Internet and a USB port.

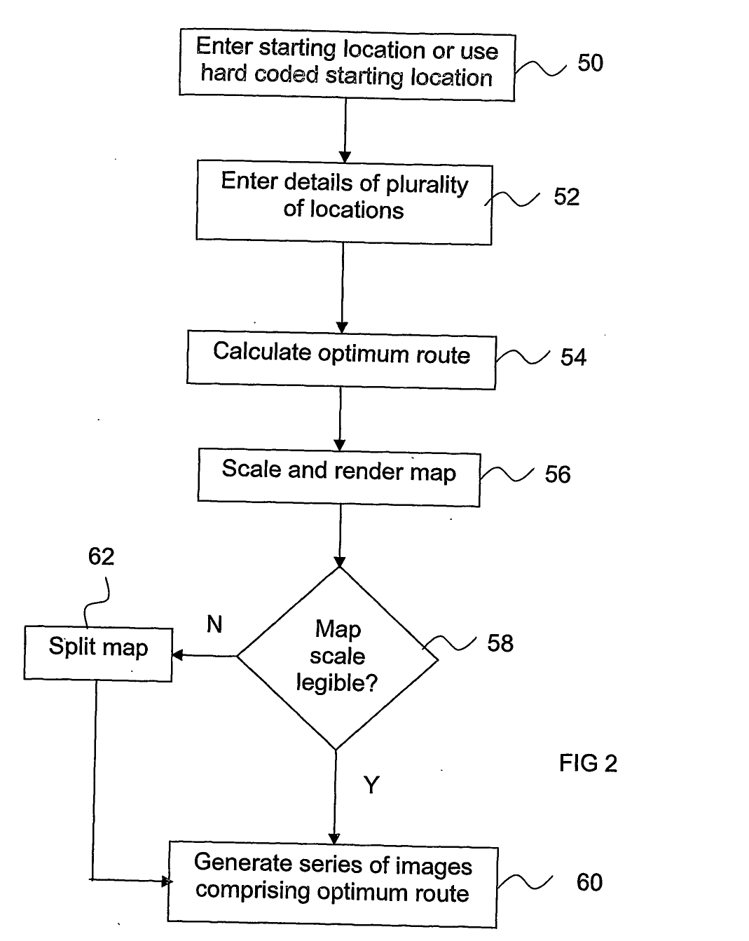

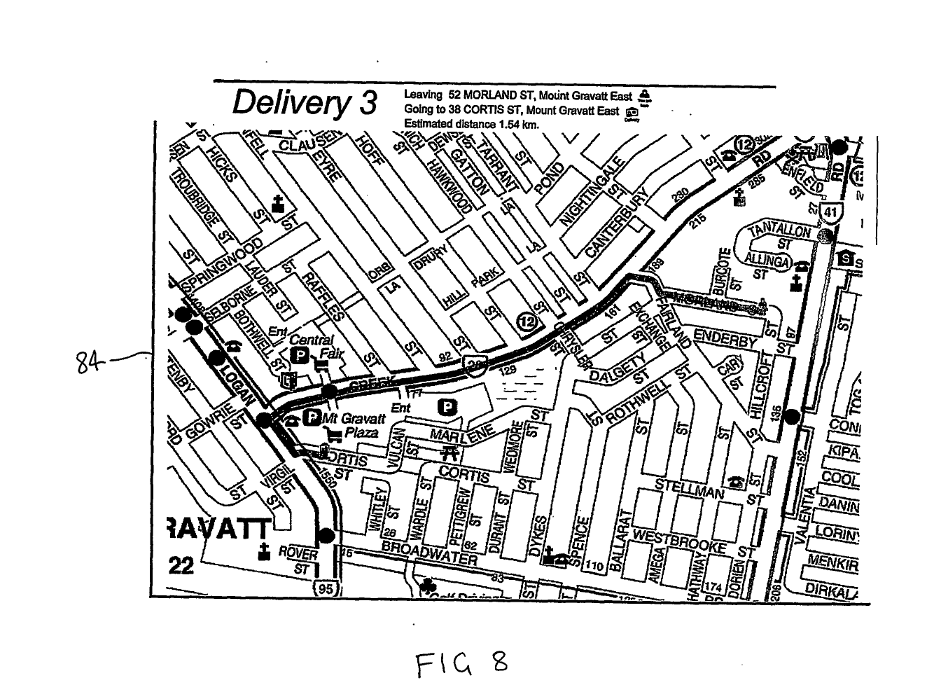

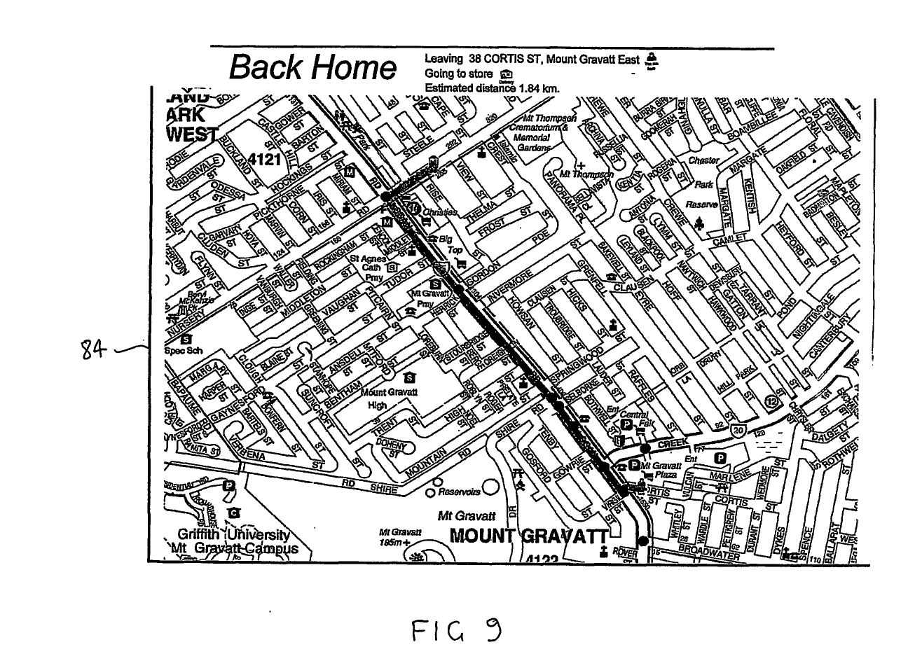

The method of the present invention will now be described with reference to the flowchart if FIG. 2 and FIGS. 3-10. With reference to step 50, in the case where a starting point for a route is fixed, such as in the pizza delivery example described above, the starting location may be hard coded into the apparatus 2. Alternatively, if the starting point can vary, such as with courier deliveries and collections, the starting location can be entered via input means 4.

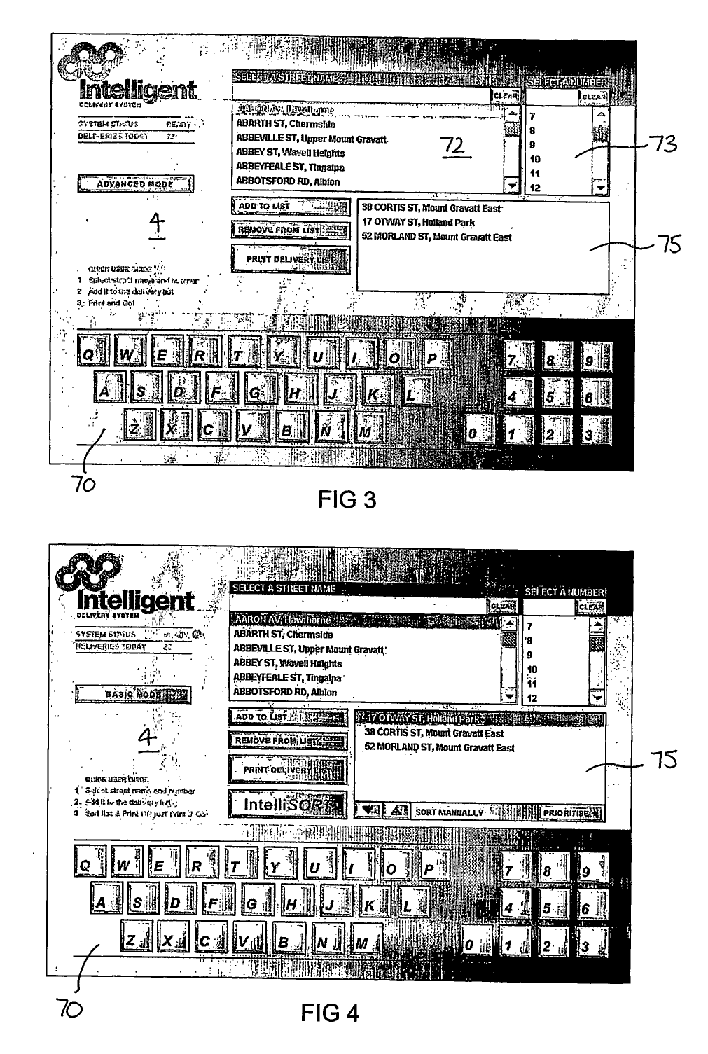

As represented by step 52, details of the plurality of locations are entered via input means 4 and processed by processing means 6 and data handling engine 18. In a preferred embodiment, the details of a location are entered in the form of an address of the location or a partial address. As shown in FIG. 3, a user selects a street name followed by a number. The first letter or letters of the street name are entered via the displayed keyboard 70, which causes the relevant part of a menu 72 of street names to be displayed. A menu 73 of numbers is also displayed. Options for the street are displayed along with the suburb in which they are located based on the letters entered by the user. The street name and number are selected via the touch sensitive screen 4. Selected addresses can be added to and removed from a list 75 of locations. FIG. 3 shows three addresses that have been identified and selected by a user.

In a basic mode of the apparatus, the user can then request a delivery list to be printed. This will cause route calculation engine 22 to calculate an optimized route between the specified locations, as represented by step 54 in FIG. 2. In one embodiment, this is achieved by employing Dijkstra's Theorem, although there are other known methods of calculating an optimized route. The route calculation engine 22 may be a commercially available engine from, for example, Mapinfo. In the basic mode, the route calculation engine calculates the optimized route according to the order in which the locations appear in the list 75.

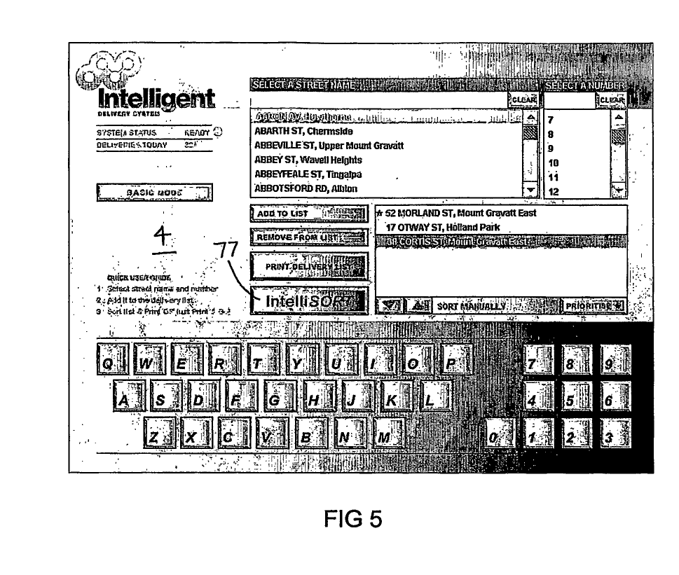

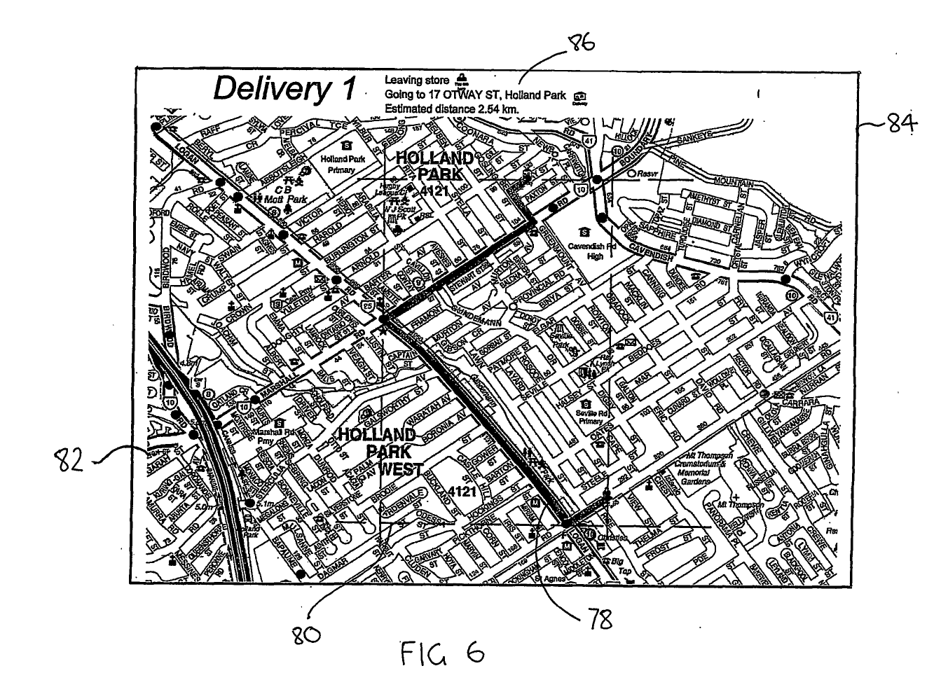

In an advanced mode of the apparatus, the user is able to change the order of the locations in the list 75 manually or automatically. As shown in FIG. 4, the Otway St. location has been placed by the user at the top of the list such that it will be the first destination of the optimized route, followed by the Cortis St. location and so on. In another advanced mode example, one or more locations can be prioritized by the user such that the prioritized location is locked into a first or other position in the list. More than one location may be prioritized and its position in the list thus preserved. As shown in FIG. 5, the Morland St. location has been prioritized. This location will not be considered in the order optimization calculation performed by the route calculation engine 22. In a further advanced mode example, an “intellisort” option 77 re-orders the locations to place them in an optimum order as part of the route optimization calculation. If one or more locations have been prioritized and their positions in the list preserved, the “intellisort” option will maintain their preserved positions.

As an alternative to specifying a street name and number, the location could be identified on the basis of a customer identifier, such as a customer name, telephone number or customer code. The association between the customer identifier and the location is stored in customer database 28.

In calculating the optimized route, the route calculation engine 22 takes into account not only distances to be traversed, but other factors that could be relevant, such as the location of one-way streets, traffic lights, roundabouts, no right turns, road closures and restrictions and the like, speed limits and/or traffic density variations over time, such as peak hour traffic flows, the durations thereof and occurrence times and the like.

In one embodiment, the apparatus and method of the present invention also includes provisions for updating or supplementing the route calculation engine 22 with transient route modifications. Feedback, such as updating or supplementing the route calculation engine 22 with, for example, temporary road closures, such as traffic accidents, may be utilized. Such updated information is provided in substantially real time through an Internet feed. Alternatively, or additionally, the user may specify the road, or section thereof, that has been temporarily closed. Calculation of the optimized route will then factor in the updates.

The optimized routes are calculated based on the distances between target locations and the other factors as specified herein, such as speed limits, traffic lights and traffic densities at particular times of the day. The system will comprise a clock so that the time of day can be factored into the route optimization calculation. For example, certain speed restrictions or high traffic densities will only apply during specified periods.

Referring to FIG. 6, the optimized route 78 is stored as a series of points defined by latitude and longitude coordinates. The overall route is comprised of a series of shorter routes between locations. For example, the overall route may be between an origin and a first location, as shown in FIG. 6, then from the first location to a second location and so on. At least each leg of the overall route is optimized, if not the overall route as a whole. With reference to step 56 in FIG. 2 and FIG. 6, the scaling module 24 samples the series of points comprising each part of the overall route to determine the maximum and minimum latitude and longitude coordinates for each part of the overall optimized route. Lines drawn along the maximum and minimum latitude and longitude coordinates define a quadrilateral 80 to which a buffer or border is added to define a larger, buffered quadrilateral 82. The buffered quadrilateral represents an area of a map that is to be displayed to show the relevant part of the optimized route. The buffer or border allows a larger area to be viewed than just the optimized route and aids in selection of the appropriate data from image file 26 and in user interpretation of the map.

Image file 26, such as a tagged image file (.tif) or bitmap file (.bmp), in the form of a map for a specific geographic area, such as a city, country or the like, such as those available from Sensis. Scaling module 24 selects an area of image file 26 according to the buffered quadrilateral 82, i.e. the area of the map required to display that part of the optimized route. Map rendering engine 20 renders a first layer of a final image corresponding to the selected area of the map. A second layer of the final image generated by the map rendering engine comprises a series of points representing that part of the optimized route. The map rendering engine 20 then merges the first and second layer to generate an image comprising a map with the relevant part of the optimized route. Each part or leg of the optimized route is generated in the same way to produce a series of images, each image 84 comprising an automatically scaled image in the form of a map comprising part of the optimized route. Each image also comprises headline information 86, such as “Delivery 1”, a brief description, such as “leaving the store”, a destination location and an estimated distance between the two locations. Each image is then printed out onto a separate sheet of printable media by output means 12, such as a conventional full width printer. Printable media includes conventional paper, card and the like, but also includes electronic paper employing electronic ink. Alternatively, the images may be downloaded to a portable electronic device that a user may take with them along the route.

Hence, FIGS. 6-9 show a series of images 84 in the form of maps, one for each part or leg of the optimized route 78. The example shown is for the delivery of pizzas to a plurality of locations and the series comprises deliveries 1-3 and a fourth image showing an optimized route from the final location back to the store. Each image comprises a map of optimum scale to display the relevant part of the optimized route as clearly as possible according to the area covered by the part of the optimized route being generated.

In contrast to the often simple and difficult to understand maps of the prior art, the images of the present invention comprise maps that include symbols that aid in interpretation and position location. The features that the symbols represent include schools, colleges, universities, parks, barbeque areas, rivers, lakes, oceans, beaches, mountains, sporting grounds such as football fields, lawn bowl greens, swimming pools, shopping centres, churches, halls, other large building structures, car parks, phone booths, post boxes, roundabouts, traffic lights, one-way streets, railways lines, railway stations, freeway on- and off-ramps (numbered), street-segment numeration and pictorial representations of the start and end points of each part or leg of the optimized route.

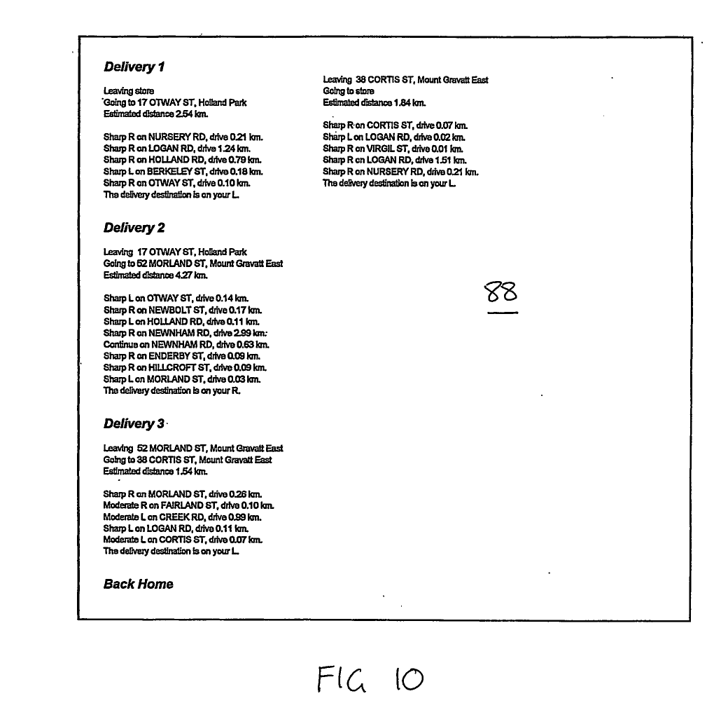

FIG. 10 shows a list of directions 88 corresponding to the optimized routes shown on the maps, which is generated in addition to the images 84. Each part of the optimized route is divided into a series of directions, each direction including, for example, a directional indication such as sharp left or right, a street name and a distance. The severity of a turn may also be stated to aid in following the directions. For example, if the direction is stated only as left or right, a user may be expecting an intersection. However, the road may only bend slightly to the left or right, thus causing confusion. The angle of a turn is therefore calculated and classified according to the number of degrees. For example, up to 20 degrees may constitute a gentle turn, 20-60 degrees a moderate turn and 60-90 degrees a sharp turn. Hairpin turns are also catered for and in one embodiment each turn category includes an associated icon.

Once an image has been generated by the map rendering engine 20, a user can view the image before printing. With reference to step 58 in FIG. 2, if the scale of the map causes the map to be unclear or difficult to read for the user, e.g. where the route covers a large distance, the user is able to select a map splitting function, represented by step 62, that splits the image into two or more separate images. The user selects one or more points at which the image is split via the user interface 4 by specifying one or more features along the optimized route at which the image is to be split. The feature(s) may be one of the directions shown in FIG. 10. Therefore, that part or leg of the optimized route will be generated on two or more separate images.

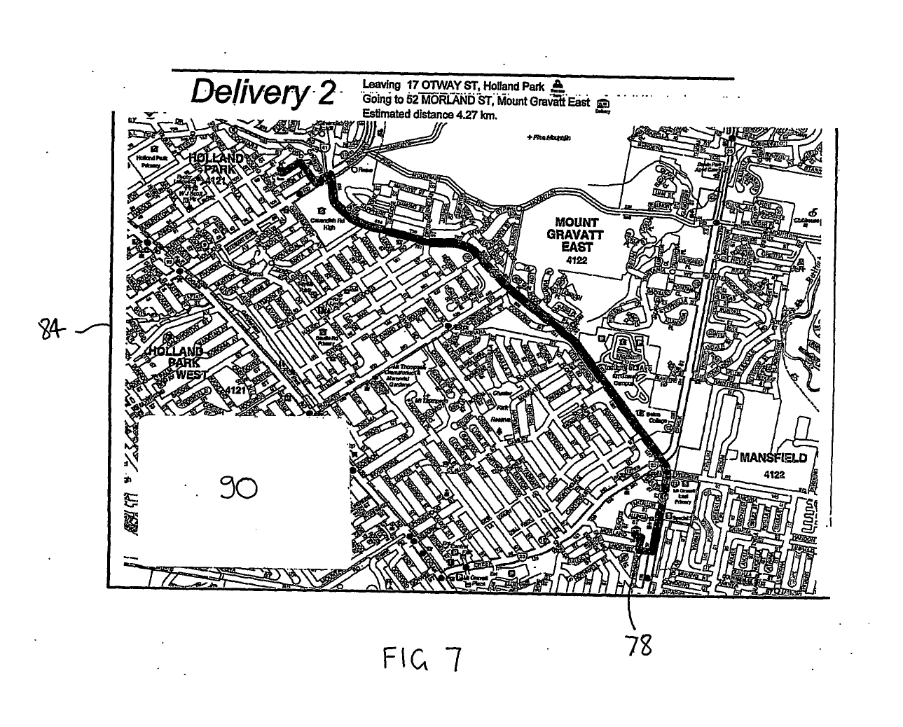

In one embodiment, one or more advertisements 90 are also generated by advertisement engine 30 and added to the rendered image as another layer or with the headline information, as shown in FIG. 7. In a preferred embodiment, the advertisements are related to businesses located in the region shown on the image. Hence, in a pizza delivery scenario for example, once a user has finished with the first image for directing him/her to the first delivery location, the user no longer needs the map and this is presented with the pizza to the customer for advertising purposes. The area of the image occupied by the advertisement(s) can be variable. This also provides another revenue stream for the user of the apparatus of the present invention.

In another embodiment, the apparatus and method includes other marketing functionality and management tools. For example, apparatus 2 stores in memory 8 data that is later analysed to aid management in identifying where the most business is from and how best to effectively advertise in areas in need of building up. Examples of data recorded by the apparatus include the coordinates of each location, the date and time of delivery and frequency of deliveries to those locations. From this very basic data, the user can determine where most sales/business are originating from, peak operational periods and the origin of repeat business. Such data can be over-laid with, for example, census data resulting in a detailed set of information very much demographically based to provide management with a demographic analysis including gender mix, income bracket, age, and the like. This facilitates effective planning of specific advertising campaigns to improve business by clearly defining the areas and the demographics to be focused on. With clear and precise historical data on the peak times and dates, management are assisted with HR planning, thus removing guesswork. By identifying the location of loyal and repeat customers, management can create special promotional programs to ensure that this valuable class of customers remain as such for as long as is possible.

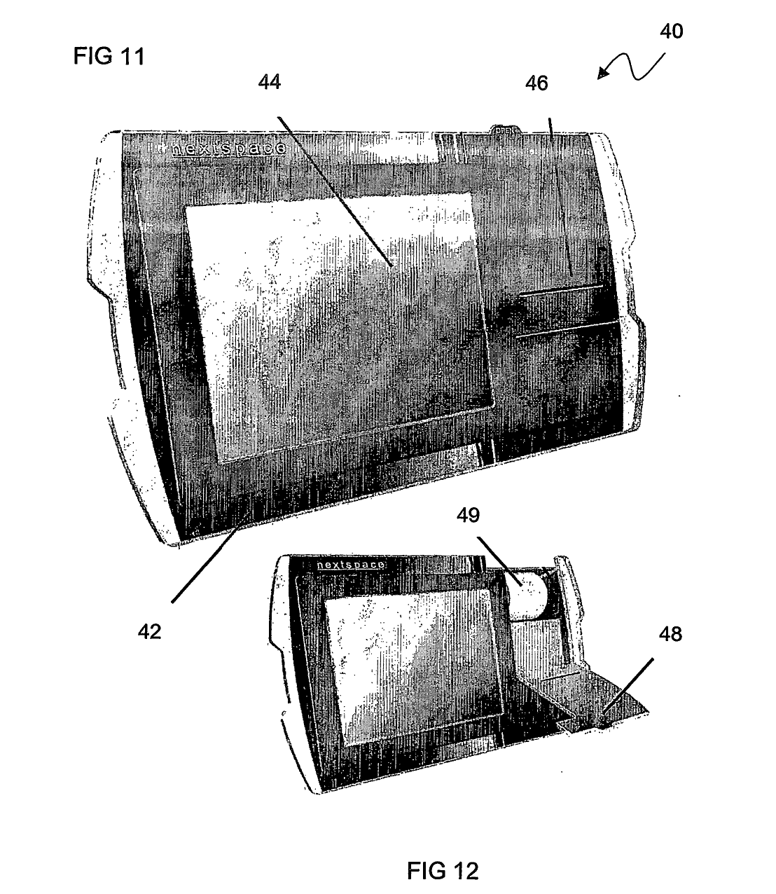

With reference to FIGS. 11 and 12, one embodiment of the apparatus is in the form of a portable unit 40, which comprises a strong, lightweight housing 42 formed from, for example, acrylic and a high resolution, touch-sensitive colour LCD screen 4 familiar to those skilled in the relevant art. A small, high speed thermal printer 46 may be incorporated into, or coupled to, the unit 40 to generate, for example, a receipt or hard copy of a map of the optimized route. As shown in FIG. 12, unit 40 may comprise a flip-down access panel 48 that enables quick and easy replacement of paper roll 49. However, in a preferred embodiment, apparatus 40 is coupled to be in communication with a full width printer 12 for the output of, for example, A4 size printable media comprising the images.

Hence, the apparatus and method of the present invention enable an optimized route between a plurality of locations to be easily, rapidly and accurately generated. The use of updateable, stored geographic data obviates the need for expensive GPS systems, rendering the provision of multiple units of the apparatus 2 to, for example, couriers and pizza companies, a more viable option. Each part or leg of the optimized route is generated on a separate page of printable media, which facilitates easy comprehension of the route. This obviates the need for multiple parts of the route to be displayed on a single map, which can be difficult to distinguish. The raster data employed in the image file 26 comprises more map details than, for example, the vector data utilized by GPS receivers. The scaling module 24 ensures that the optimum scale is employed for each part of the optimized route so that each part or leg of the route is generated as clearly as possible. This avoids the problem of a single scale being employed on a single display for all parts of an optimized route, which can render parts of the route difficult to follow. Where the scale of the map is small despite the scaling facility, the map splitting function of the present invention addresses this problem. However, each user has the option to split each image as desired to cater for users with different eyesight qualities. Furthermore, once the map has been utilized, the map is not wasted, but put to good use as an advertising vehicle by virtue of the advertisements generated on a part of the map, the advertisements preferably being geographically dependent.

It will be appreciated that the present invention is not limited to the examples described above and the present invention could be applied to any scenario in which it is desirable to optimize a route between a plurality of locations. For example, the present invention could be applied to pathology delivery and collection where samples have to be collected from and delivered back to medical practices in various locations and delivered to and from a pathology laboratory. Samples usually have different time frames attached to their processing and such time frames may be factored into the optimized delivery method and apparatus of the present invention.

Another application of the present invention could be the delivery of concrete by mobile mixers to a plurality of locations. Conventionally, an order for concrete needs to be over a minimum volume because it is not possible to deliver small volumes of concrete to a plurality of locations before the concrete dehydrates and is therefore unusable because of the deterioration of its strength characteristics and the like. By virtue of the present invention, optimization of the delivery route, and therefore delivery times, to multiple locations permits smaller volumes of concrete to be delivered before the concrete becomes unusable. This increases revenue for the concrete company an enables customers requiring small volumes to use their services.

Further applications of the present invention include the delivery to and/or collection of goods from multiple customers at different locations such as the delivery of purchased items by department stores or supermarkets to a plurality of customers.

Throughout the specification the aim has been to describe the invention without limiting the invention to any one embodiment or specific collection of features. Persons skilled in the relevant art may realize variations from the specific embodiments that will nonetheless fall within the scope of the invention.

1. A method of generating an optimized route between a plurality of locations, said method including the steps of:
(a) identifying the plurality of locations;
(b) converting the locations into data representative of said plurality of locations by reference to a store of geographic data;
(c) calculating an optimized route between the plurality of locations on the basis of said representative data; and
(d) generating a series of images, each image of said series comprising a part of the optimized route between two of the identified locations.

2. The method of claim 1, wherein step (b) includes determining longitude and latitude coordinates representing each location by referring to a look-up table.

3. The method of claim 1, wherein step (d) includes automatically scaling each image on the basis of the part of the optimized route to be generated on said image.

4. The method of claim 1, further including the step of defining each point along the optimized route in terms of longitude and latitude coordinates.

5. The method of claim 3, wherein the step of automatically scaling each image further includes determining maximum and minimum longitude and latitude coordinates of the optimized route.

6. The method of claim 1, further including the step of splitting an image into two or more images where an automatically determined scale of the image renders information of the image unclear or illegible to a user.

7. The method of claim 6, further including the step of a user selecting one or more features along the optimized route at which to split the image.

8. The method of claim 1, further including the step of generating one or more advertisements on one or more parts of one or more of the images.

9. The method of claim 8, further including the step of selecting one or more of the advertisements on the basis of a region represented by the image.

10. The method of claim 1, wherein an origin and/or a destination of the optimized route are automatically specified prior to calculating the optimized route.

11. The method of claim 1, further including the step of specifying one of said plurality of locations to be the first destination of the optimized route.

12. The method of claim 1, wherein step (c) includes preserving an order of the plurality of locations and optimising the route between each location.

13. The method of claim 1, wherein each image is a map printed onto a separate sheet of printable media.

14. The method of claim 1, wherein each image is a visual electronic representation of a map stored on a portable electronic device.

15. The method of claim 1, wherein step (a) includes specifying a customer identifier to identify a location by reference to a store of customer data.

16. An apparatus for generating an optimized route between a plurality of locations, said apparatus comprising:
processing means coupled to be in communication with:
input means for identifying the plurality of locations;
storage means for storing geographic data;
a data handling engine for converting the locations into data representative of said plurality of locations by reference to said storage means;
a route calculating engine for calculating an optimized route between the plurality of locations on the basis of said representative data;
an image rendering engine for generating a series of images, each image of said series comprising a part of the optimized route between two of the identified locations; and
output means for outputting said series of images.

17. The apparatus of claim 16, wherein said storage means comprises a look-up table of longitude and latitude coordinates representing each location.

18. The apparatus of claim 16, further comprising a scaling engine for automatically scaling each image on the basis of the part of the optimized route to be represented on said image.

19. The apparatus of claim 16, further comprising a store of customer data to identify at least one of the locations on the basis of a customer identifier.

20. The apparatus of claim 16, further comprising an advertising engine for selecting one or more advertisements to be added to one or more images.

21. The apparatus of claim 16, wherein said input means is a graphical user interface.

22. The apparatus of claim 16, wherein said input means is a touch sensitive screen.
